(19) United States
(12) Patent Application Publication
(10) Pub. No.: US 2025/0374132 A1
(43) Pub. Date: Dec. 4, 2025

(54) NR MOBILITY - SECURITY CONSIDERATIONS FOR L1/L2 MOBILITY SWITCHING OF AN SPCELL

(71) Applicant: InterDigital Patent Holdings, Inc., Wilmington, DE (US)

(72) Inventors: Oumer Teyeb, Montreal (CA); Brian Martin, Farnham (GB); Paul Marinier, Brossard (CA); Martino Freda, Laval (CA); Keiichi Kubota, Setagaya-Ku (JP)

(73) Assignee: InterDigital Patent Holdings, Inc., Wilmington, DE (US)

(21) Appl. No.: 18/997,416

(22) PCT Filed: Aug. 4, 2023
(86) PCT No.: PCT/US2023/071654

§ 371 Date: Jan. 21, 2025

Related U.S. Application Data
(60) Provisional application No. 63/395,161, filed on Aug. 4, 2022.

(51) Int. Cl. H04W 36/00; H04W 12/03

(52) U.S. Cl. CPC H04W 36/0072; H04W 12/03; H04W 36/0038

(57) ABSTRACT

A wireless transmit/receive unit (WTRU) may be configured to process first downlink data from a source cell using a first security context. The WTRU may receive, from the source cell, configuration information indicating one or more candidate cells for Layer 1 or Layer 2 (L1/L2) triggered mobility (LTM). The WTRU may receive, from the source cell, a LTM indication to perform a handover (HO) to a candidate cell among the one or more candidate cells. The WTRU may determine a second security context associated with the candidate cell. The WTRU may process second downlink data based on the first security context. The WTRU may process third downlink data from the candidate cell using the second security context upon a determination that one or more of the conditions are met.

### CROSS REFERENCE TO RELATED APPLICATIONS

This application claims the benefit of U.S. Provisional Application No. 63/395,161 filed Aug. 4, 2022, the entire contents of which are incorporated herein by reference.

### BACKGROUND

A gNB key (e.g., K_{gNB}) may be used to derive integrity protection/verification and encryption/decryption keys for UP and/or CP, and may be dependent on physical cell ID (PCI) and the frequency of a PCell. In L3 handover (e.g., the reception of a HO command or the execution of a CHO), a wireless transmit/receive unit (WTRU) may be explicitly indicated to update the security keys and also re-establish the PDCP and RLC. These, along with the reset of the MAC, may ensure that the WTRU will not send any pending UL data that was already encrypted and/or integrity protected using the old security keys, and the WTRU may not try to use the new security keys to decrypt and/or integrity verify DL data that has been encrypted and/or integrity protected with the old keys.

To apply the current behavior of security and associated protocol handling during L1/L2 mobility (e.g., security updates, PDC/RLC re-establishment, MAC reset, etc.), the WTRU may be configured with additional reconfiguration that it may store and apply on the reception of the L1/L2 message (e.g., a stored radio bearer and associated PDCP configuration to set the PDCP re-establishment flag, a stored RLF bearer configuration to set the RLF re-establishment flag, etc.). Additionally, the PDCP/RLC re-establishment and MAC reset may lead to a latency increase during the handover procedure, as packets that were in flight may be retransmitted (after being re-encoded with the new security keys), and packets that were already processed at PDCP/RLC level and are waiting to be transmitted at the MAC level are to be reprocessed, which is not desirable as the main objective of introducing L1/L2 mobility is latency enhancement.

### SUMMARY

A wireless transmit/receive unit (WTRU) may be configured to process first downlink data from a source cell using a first security context. The WTRU may receive, from the source cell, configuration information indicating one or more candidate cells for Layer 1 or Layer 2 (L1/L2) triggered mobility (LTM). The WTRU may receive, from the source cell, a LTM indication to perform a handover (HO) to a candidate cell among the one or more candidate cells. Prior to receiving the LTM indication to perform the HO, the WTRU may transmit first uplink data to the source cell using the first security context. The WTRU may determine a second security context associated with the candidate cell. The WTRU may process second downlink data using the first security context. The WTRU may process third downlink data from the candidate cell using the second security context upon a determination that one or more conditions are met. The conditions may comprise a determination that a certain time has elapsed from the reception of the LTM indication to perform the HO, a determination that an integrity verification with one or more old security keys has failed, and/or a determination that an end marker packet is received. After receiving the LTM indication to perform the HO, the WTRU may transmit second uplink data to the candidate cell that is encrypted using the second security context

The end marker packet may comprise one or more of a dummy radio resource control (RRC) message, a packet data convergence protocol (PDCP) control protocol data unit (PDU) that comprises an indication to use the second security context, or a field in a PDCP data PDU header that comprises an indication to use the second security context. The WTRU may be configured to, prior to receiving the LTM indication to perform the HO, transmit first uplink data to the source cell using the first security context. The WTRU may be configured to, after receiving the LTM indication to perform the HO, transmit a second uplink data to the candidate cell that is encrypted using the second security context. The WTRU may be configured to, after the determination that one or more of the conditions are met, transmit third uplink data that is encrypted using the second security context. The one or more old security keys may be associated with the first security context. The WTRU may be configured to use the second security context, and refrain from using the first security context, upon the determination that one or more of the conditions are met.

The first security context may comprise one or more security keys. Determining the second security context may comprise deriving a new key for the candidate cell (KgNB) and calculating, using a physical cell identification (PCI) and a frequency of a primary cell (PCell), one or more integrity protection keys and decryption keys using the candidate cell. Processing the third downlink data may comprise performing integrity verification and decryption using the one or more integrity protection keys and decryption keys associated with the second security context. The LTM indication to perform the HO may indicate that a special cell (SpCell) associated with the WTRU is to be changed. The WTRU may be further configured to refrain from performing re-establishment of radio resource control (RRC), packet data convergence protocol (PDCP), and radio link control (RLC) entities. The WTRU may be further configured to refrain from resetting medium access control (MAC) and physical layer entities.

A WTRU may implicitly trigger PDCP and RLC re-establishment of one or more (e.g., all or a subset of) bearers upon the reception of an L1/L2 mobility indication that changes the SpCell. The WTRU may refrain from performing PDCP and RLC re-establishment of the bearers upon reception of an L1/L2 mobility indication that changes the SpCell. The WTRU may use the old security keys for integrity verification and/or decryption until a certain time has elapsed after the reception of the L1/L2 mobility indication, until integrity verification using the old keys fails, and/or until an end marker packet (e.g., PDCP control PDU or a PDCP data PDU containing a flag indicating the security context switch, etc.) is received. The WTRU may be configured with multiple security contexts and may be instructed to use a certain security context (e.g., at a bearer level, at a packet level, for UL or DL, etc.).

In an example, a WTRU may receive an L1/L2 mobility indication that changes the SpCell. The WTRU may refrain from performing the re-establishment of the PDCP and RLC entities. The WTRU may refrain from resetting the MAC entity. The WTRU may calculate a new security context (e.g., derive the new K_{gNB} based on the new PCI and frequency of the new PCell, and/or calculate the integrity protection and encryption keys for both the UP and CP based on the new K_{gNB}). In the UL (PDCP), the WTRU may, for any new data to be transmitted at the PDCP level, integrity protect and/or encrypt the packet using the keys from the new security context, and for old data that is already integrity protected and/or encrypted using the old security keys, pass the data to the RLC/MAC entities. In the DL (PDCP), the WTRU may keep using the old security context until one or more of the following conditions is met: a certain time has elapsed from the reception of the L1/L2 mobility indication; an integrity verification with the old security keys fails; or an end marker packet (e.g., a special/dummy RRC message, a PDCP control PDU that indicates to apply the new security context, a field in the PDCP data PDU header that indicates to switch to the new security context, etc.) is received. When one or more of the previous conditions are met, the WTRU may delete the old security context and use (e.g., only) the new security keys.

A WTRU may be configured to have several security contexts simultaneously. A (e.g., each) security context may be associated with a given identity. The WTRU may receive an indication of the identity of the security context to use for a given bearer, for a given backet, for UL or DL, etc.

Mechanisms for reducing the signaling and latency related to security-related configurations/actions during L1/L2 mobility are disclosed herein.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment.

FIG. 2 illustrates an example of a handover procedure that may be used in new radio (NR).

FIG. 3 illustrates an example of key hierarchy generation in NR.

FIG. 4 illustrates an example of horizontal key derivation (HKD) and vertical key derivation (VKD).

FIG. 5 illustrates an example of Layer 1 or Layer 2 (L1/L2) inter-cell mobility operation.

FIG. 6 illustrates an example of L1/L2 triggered mobility (LTM) using and old security context and/or a new security context.

### DETAILED DESCRIPTION OF THE INVENTION

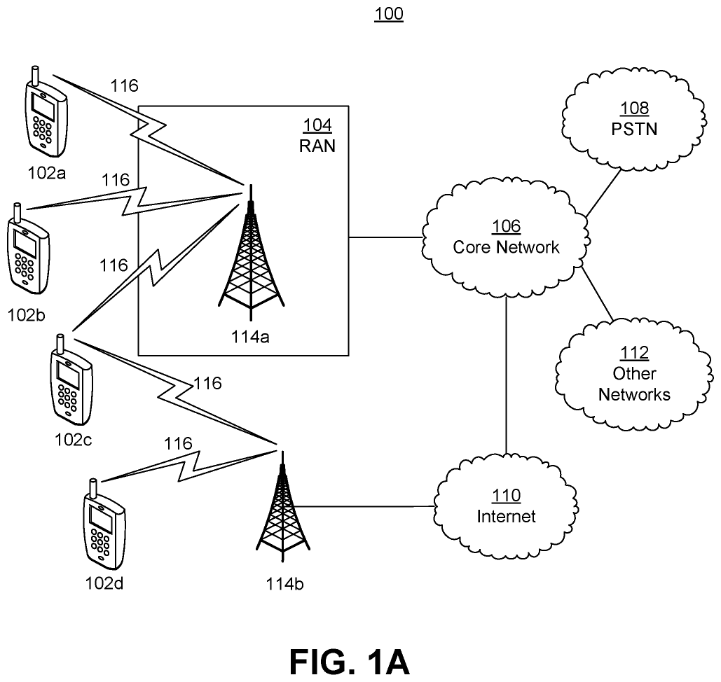

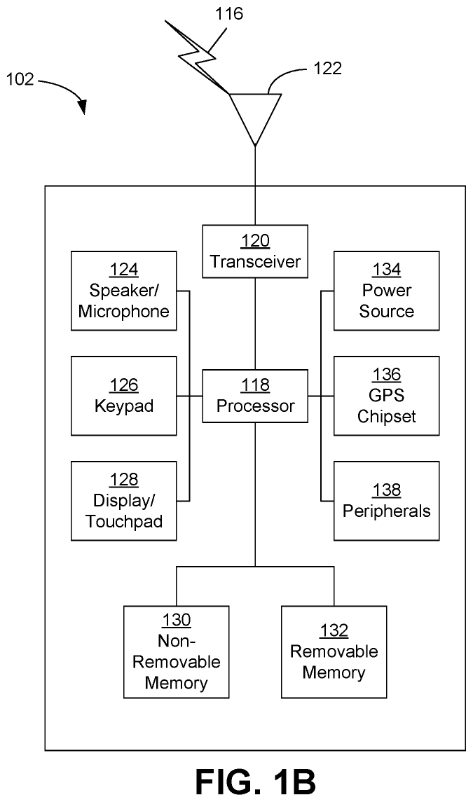

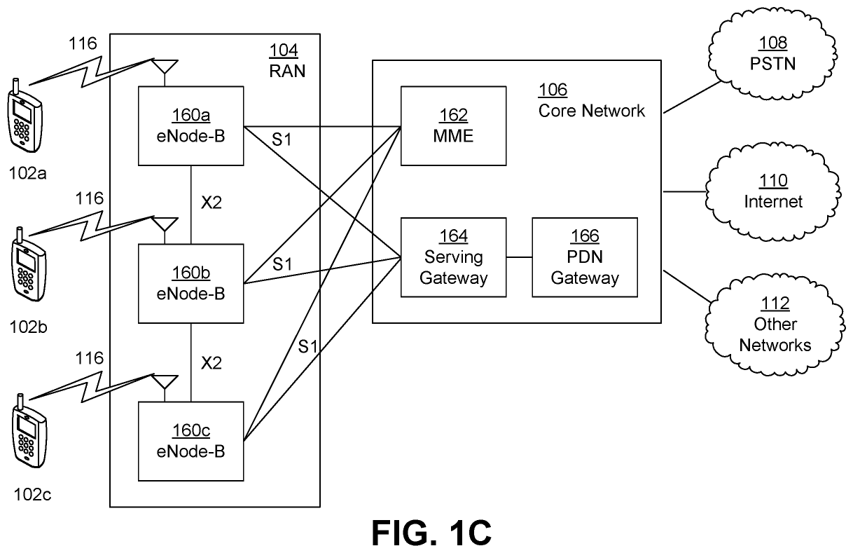

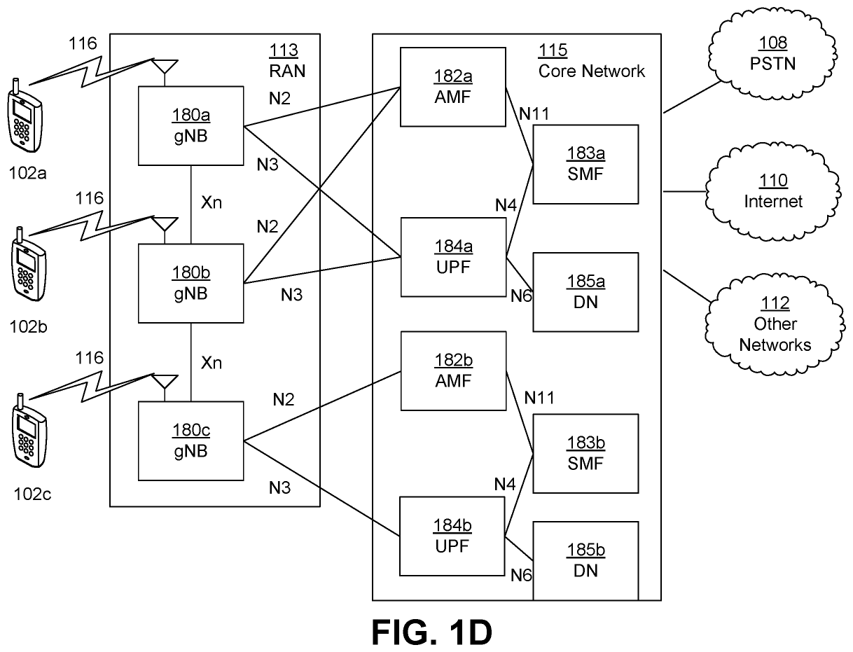

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may comprise wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may comprise a wireless transmit receive unit (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also comprise a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may comprise any number of interconnected base stations and/or network elements.

The base station 114a may be part of the RAN 104/113, which may also comprise other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may comprise three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may comprise communication protocols such as High-Speed Packet Access (HSPA) and/or Evolved HSPA (HSPA+). HSPA may comprise High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may comprise circuit-switched telephone networks that provide plain old telephone service (POTS). The Internet 110 may comprise a global system of interconnected computer networks and devices that use common communication protocols, such as the transmission control protocol (TCP), user datagram protocol (UDP) and/or the internet protocol (IP) in the TCP/IP internet protocol suite. The networks 112 may comprise wired and/or wireless communications networks owned and/or operated by other service providers. For example, the networks 112 may comprise another CN connected to one or more RANs, which may employ the same RAT as the RAN 104/113 or a different RAT.

Some or all of the WTRUs 102a, 102b, 102c, 102d in the communications system 100 may comprise multi-mode capabilities (e.g., the WTRUs 102a, 102b, 102c, 102d may comprise multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may comprise a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may comprise any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may comprise any number of transmit/receive elements 122. More specifically, the WTRU 102 may employ MIMO technology. Thus, in one embodiment, the WTRU 102 may comprise two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may comprise multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may comprise random-access memory (RAM), read-only memory (ROM), a hard disk, or any other type of memory storage device. The removable memory 132 may comprise a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may comprise one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may comprise one or more software and/or hardware modules that provide additional features, functionality and/or wired or wireless connectivity. For example, the peripherals 138 may comprise an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may comprise one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may comprise a full duplex radio for which transmission and reception of some or all of the signals (e.g., associated with particular subframes for both the UL (e.g., for transmission) and downlink (e.g., for reception) may be concurrent and/or simultaneous. The full duplex radio may comprise an interference management unit 139 to reduce and or substantially eliminate self-interference via either hardware (e.g., a choke) or signal processing via a processor (e.g., a separate processor (not shown) or via processor 118). In an embodiment, the WRTU 102 may comprise a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may comprise eNode-Bs 160a, 160b, 160c, though it will be appreciated that the RAN 104 may comprise any number of eNode-Bs while remaining consistent with an embodiment. The eNode-Bs 160a, 160b, 160c may each comprise one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may comprise a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may comprise, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may comprise other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may comprise a battery with a battery life above a threshold (e.g., to maintain a very long battery life).

WLAN systems, which may support multiple channels, and channel bandwidths, such as 802.11n, 802.11ac, 802.11af, and 802.11ah, comprise a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may comprise gNBs 180a, 180b, 180c, though it will be appreciated that the RAN 113 may comprise any number of gNBs while remaining consistent with an embodiment. The gNBs 180a, 180b, 180c may each comprise one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may comprise at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may comprise, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may comprise other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may comprise one or more antennas) may be used by the emulation devices to transmit and/or receive data.

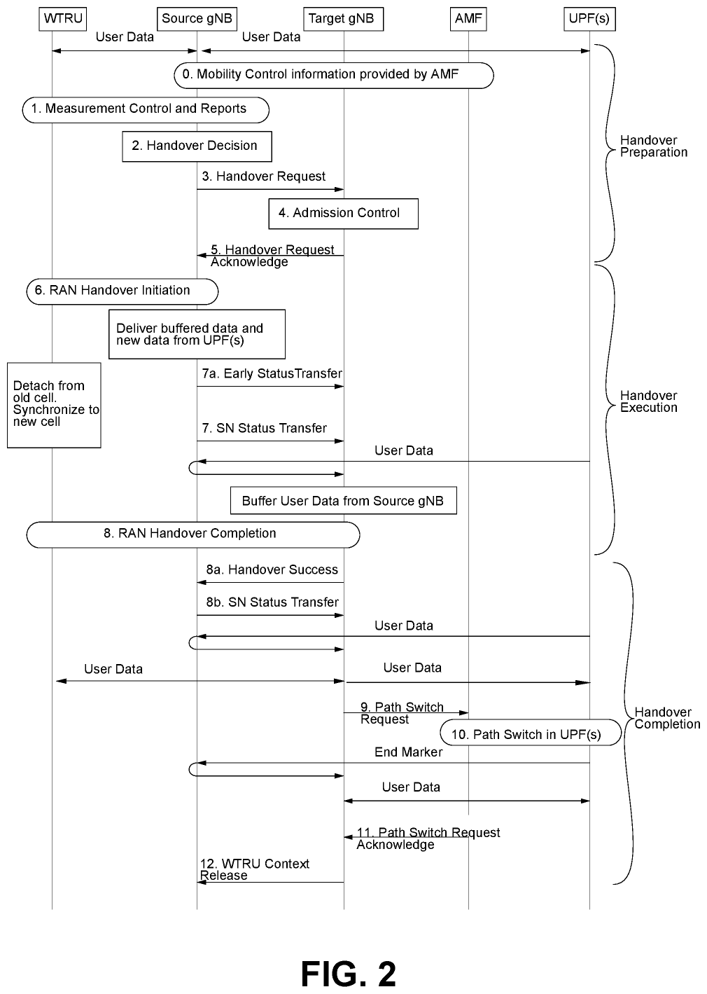

FIG. 2 illustrates an example of a handover procedure that may be used in new radio (NR). As shown in FIG. 2, a wireless transmit/receive unit (WTRU) context within a source gNB may contain information regarding roaming and access restrictions, which may be provided either at connection establishment or at a previous timing advance (TA) update. The Mobility Control information may be provided to the WTRU, source gNB, and/or the target gNB by the (AMF). The source gNB may configure the WTRU measurement procedures, and the WTRU may report according to its measurement configuration. The source gNB may decide to handover the WTRU based on the received measurements. The source gNB may issue a Handover Request message to the target gNB passing a transparent RRC container with information to prepare the handover at the target side. The information may comprise at least the target cell ID, K_{gNB}*(e.g., the K_{gNB} that may be used between the WTRU and the target gNB), the C-RNTI of the WTRU in the source gNB, RRM-configuration including WTRU inactive time, basic AS-configuration including antenna Info and DL Carrier Frequency, the current QoS flow to data radio bearer (DRB) mapping rules applied to the WTRU, the SIB1 from the source gNB, the WTRU capabilities for different RATs, PDU session related information, and/or the WTRU-reported measurement information including beam-related information, if available.

Admission control may be performed by the target gNB. If the WTRU can be admitted, the target gNB may prepare the handover with L1/L2 and may send the HANDOVER REQUEST ACKNOWLEDGE to the source gNB, which may comprise a transparent container to be sent to the WTRU as an RRC message to perform the handover. The source gNB may trigger the UMTS Air Interface (Uu) handover by sending an RRCReconfiguration message to the WTRU, containing the information to access the target cell: the target cell ID, the new C-RNTI, the target gNB security algorithm identifiers for the selected security algorithms, etc. Uu may also be known as wideband code division multiple access (W-CDMA) and/or international mobile telecommunications (IMT) Direct Spread. Uu may comprise a radio interface between the UMTS Terrestrial Radio Access Network (UTRAN) and the WTRU utilizing Code Division Multiple Access (CDMA). The information may also comprise a set of dedicated RACH resources, the association between RACH resources and SSB(s), the association between RACH resources and WTRU-specific CSI-RS configuration(s), common RACH resources, system information of the target cell, etc.

The source gNB may send the SN STATUS TRANSFER message to the target gNB to convey the uplink PDCP SN receiver status and the downlink PDCP SN transmitter status of DRBs for which PDCP status preservation applies (e.g., for RLC AM). The WTRU may synchronize to the target cell and may complete the RRC handover procedure by sending RRCReconfiguration Complete message to the target gNB. The target gNB may send a PATH SWITCH REQUEST message to AMF to trigger 5G core (5GC) to switch the DL data path towards the target gNB and to establish an NG-C interface instance towards the target gNB. 5GC may switch the DL data path towards the target gNB. The UPF may send one or more “end marker” packets on the old path to the source gNB per PDU session/tunnel and then may release any U-plane/TNL resources towards the source gNB. The end marker packets may comprise a special/dummy RRC message, a PDCP control PDU that indicates to apply the new security context, and/ora field in the PDCP data PDU header that indicates to switch to the new security context. The AMF may confirm the PATH SWITCH REQUEST message with the PATH SWITCH REQUEST ACKNOWLEDGE message. Upon reception of the PATH SWITCH REQUEST ACKNOWLEDGE message from the AMF, the target gNB may send the WTRU CONTEXT RELEASE to inform the source gNB about the success of the handover. The source gNB may then release radio and C-plane related resources associated with the WTRU context. Any ongoing data forwarding may continue.

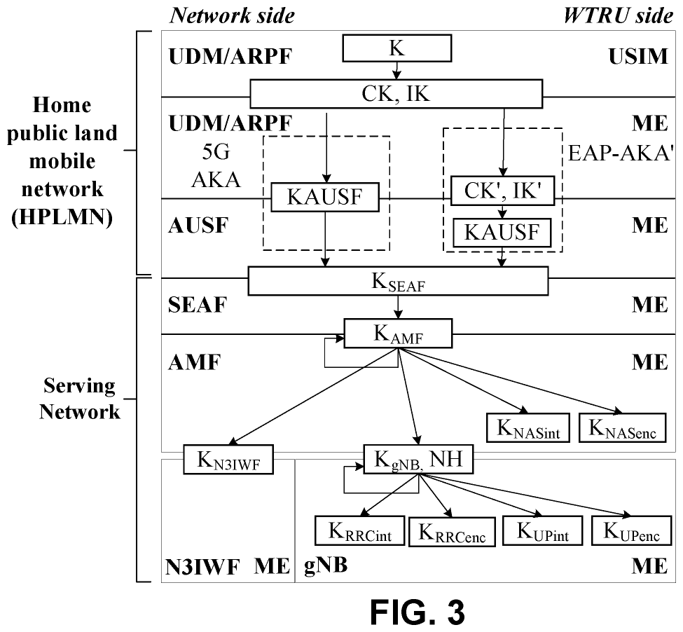

FIG. 3 illustrates an example of security key hierarchy generation/derivation in NR. As shown in FIG. 3, the key hierarchy may comprise one or more of the following keys: K_{AUSF} (Authentication Server Function key), K_{SEAF} (Security Anchor Function key), K_{AMF} (Access and Mobility Management Function key), K_{NASint} (Non-access stratum integrity key), K_{NASenc} (Non-access stratum encryption key), KN₃IWF (non-3GPP Interworking Function key), K_{gNB} (gNodeB key), K_{RRCint} (Radio resource control integrity key), K_{RRCenc} (Radio resource control encryption key), K_{UPint} (User plane integrity key) and K_{UPenc} (User plane encryption key). One or more of the preceding keys may be related to the access stratum and/or the non-access stratum (NAM). The home public land mobile network (HPLM) may comprise several sections and/or devices in which keys are derived: Unified Data Management (UDM), Authentication Credential Repository and Processing Function (ARPF), Authentication Server Function (AUSF), universal subscriber identity module (USIM), and mobile equipment (ME). The serving network may comprise several sections and/or devices in which keys are derived: Security Anchor Function (SEAF), Access and Mobility Management Function (AMF), mobile equipment (ME), gNB, and non-3GPP Interworking Function (N3IWF). K_{AUSF} may be derived on the network side in conformity with the 5G Authentication and Key Agreement (AKA). While on the WTRU side, K_{AUSF} may be derived in conformity with the Extensible Authentication Protocol AKA (EAP-AKA′).

K may be the initial key used to derive other keys. CK and IK may be derived from K. A first K_{AUSF}, CK′, and IK′ may be derived from CK and IK. A second KAUSF may be derived from CK′ and IK′. K_{SEAF} may be derived from the first K_{AUSF} (network side) and the second K_{AUSF} (WTRU side). K_{AMF} may be derived from K_{SEAF}. K_{N3IWF}, K_{gNB}, NH, K_{NASint}, and K_{NASenc} may be derived from K_{AMF}. K_{RRCint}, K_{RRCenc}, K_{UPint}, and K_{UPenc} may be derived from K_{gNB}, NH. The security key hierarchy may comprise one or more intermediate keys and vector values used during various key derivation processes.

One or more keys may be associated with Next Generation Radio Access Network (NG-RAN). For example, K_{gNB} may be a key derived by mobile equipment (ME) and Access and Mobility Management Function (AMF) from K_{AMF}. K_{gNB} may be further derived by ME and source gNB when performing horizontal or vertical key derivation. The K_{gNB} may be used as KeNB between ME and ng-eNB.

One or more keys may be associated with user plane (UP) traffic. For example, K_{UPenc} may be a key derived by ME and gNB from K_{gNB}, which may be used for the protection of UP traffic with a particular encryption algorithm. K_{UPint} may be a key derived by ME and gNB from K_{gNB}, which may (e.g., only) be used for the protection of UP traffic between ME and gNB with a particular integrity algorithm.

One or more keys may be associated with RRC signaling. For example, K_{RRCint} may be a key derived by ME and gNB from K_{gNB}, which may be used for the protection of RRC signaling with a particular integrity algorithm. K_{RRCenc} may be a key derived by ME and gNB from K_{gNB}, which may be used for the protection of RRC signaling with a particular encryption algorithm.

One or more intermediate keys may be used. For example, Next Hop (NH) may be a key derived by ME and AMF to provide forward security, and K_{NG-RAN}*(K_{gNb}* if the target is a gNB or K_{eNB}* if the target is an eNB) may be a key derived by ME and NG-RAN (e.g., gNB or ng-eNB) when performing a horizontal or vertical key derivation.

Whenever an initial access stratum (AS) security context is to be established between the WTRU and gNB, the AMF and the WTRU may derive a K_{gNB} and a Next Hop (NH) parameter. The K_{gNB} and/or the NH parameter may be derived from the K_{AMF}. An NH Chaining Counter (NCC) may be associated with an (e.g., each) K_{gNB} and/or NH parameter. A (e.g., each) KgNB may be associated with the NCC corresponding to the NH value from which it was derived. At initial setup, the K_{gNB} may be derived directly from K_{AMF}, and may then be considered to be associated with a virtual NH parameter with an NCC value (e.g., equal to zero). At initial setup, the derived NH value may be associated with another NCC value (e.g., one). On handovers, the basis for the K_{gNB} ns that will be used between the WTRU and the target gNB, called K_{gNB}*, may be derived from either the currently active K_{gNB} or from the NH parameter. Deriving K_{gNB}* from the currently active K_{gNB} may be referred to as a horizontal key derivation, and may be indicated to WTRU with an NCC that does not increase. Deriving K_{gNB}* from the NH parameter may be referred to as a vertical key derivation, and may be indicated to the WTRU with an NCC increase. Finally, K_{RRCint}, K_{RRCenc}, K_{UPint} and K_{UPenc} may be derived based on K_{gNB} after a new K_{gNB} is derived.

With such key derivation, a gNB with knowledge of a K_{gNB}, shared with a WTRU, may be unable to compute any previous K_{gNB} that has been used between the same WTRU and a previous gNB, therefore providing backward security. Similarly, a gNB with knowledge of a K_{gNB}, shared with a WTRU, may be unable to predict any future K_{gNB} that will be used between the same WTRU and another gNB after n or more handovers (e.g., since NH parameters are only computable by the WTRU and the AMF). One or more old security keys may be associated with an old (e.g., first) security context.

On handovers with vertical key derivation, the NH may be further bound to the target PCI and its frequency absolute radio frequency channel number downlink (ARFCN-DL) before it is taken into use as the K_{gNB} in the target gNB. On handovers with horizontal key derivation, the currently active K_{gNB} may be further bound to the target PCI and its frequency ARFCN-DL before it is taken into use as the K_{gNB} in the target gNB. That is, when deriving the K_{gNB}, the PCI and the ARFCN (e.g., absolute frequency of SSB of the target cell) may be used as input to the security key derivation function (KDF). Determining a new (e.g., second) security context may comprise deriving a new key for a candidate cell (KgNB) and calculating, using a physical cell identification (PCI) and a frequency (e.g., ARFCN-DL) of a primary cell (PCell), one or more integrity protection keys and decryption keys using the candidate cell. Processing downlink data may comprise performing integrity verification and decryption using the one or more integrity protection keys and decryption keys associated with the second security context.

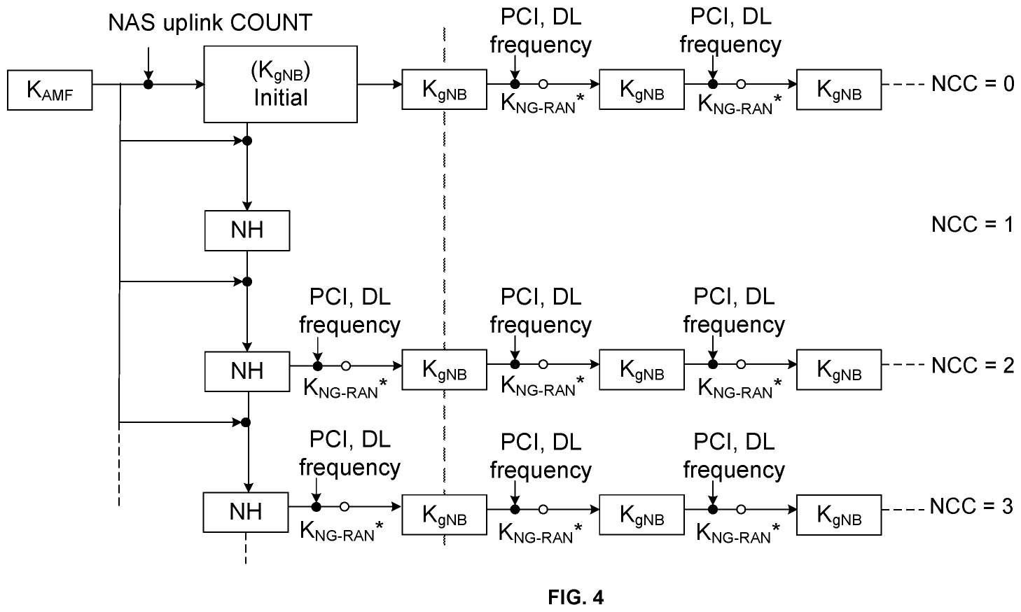

FIG. 4 illustrates an example of horizontal key derivation (HKD) and vertical key derivation (VKD).

As described herein, the K_{gNB} may be updated during a HO (e.g., using a key derivation function, KDF, that uses as input such parameters as the PCI and frequency of the new PCell, and/or other parameters such as the NCC). The integrity protection/verification and encryption/decryption keys for both the UP and CP may then be updated based on the newly derived K_{gNB}. Determining security contexts (e.g., second security context) may comprise deriving a new key for candidate cells (KgNB) and calculating, using a physical cell identification (PCI) and a frequency of a primary cell (PCell), one or more integrity protection keys and decryption keys using the candidate cell. As illustrated in FIG. 4, at each NCC level (e.g., 0, 1, 2, 3) K_{gNB} is updated based on the PCI and DL frequency. At NCC=0, K_{gNB} initial is used to begin with. But at NCC=2 and NCC=3, the NH is used to derive subsequent K_{gNBs}. K_{NG-RAN}* may be used in the intermediate steps to derive updated K_{gNBs}. Processing downlink data may comprise performing integrity verification and decryption using the one or more integrity protection keys and decryption keys associated with the second security context.

During a HO that uses a key change/update, the network may also indicate to the WTRU to re-establish the packet data convergence protocol (PDCP) and RLC entities of one or more (e.g., all) concerned bearers.

During RLC re-establishment, the WTRU may discard one or more RLC service data units (SDUs), RLC SDU segments, and/or RLC protocol data units (PDUs) (e.g., if any), stop and reset one or more (e.g., all) timers, and/or reset one or more (e.g., all) state variables to their initial values.

During PDCP re-establishment, the WTRU may perform one or more of the following for the transmitting PDCP entity (e.g., concerning UL data): for unacknowledge mode (UM) DRBs and acknowledge mode (AM) DRBs, reset the Robust Header Compression (ROHC) protocol for uplink and start with an IR state in U-mode if drb-ContinueROHC is not configured; for UM DRBs and AM DRBs, reset the EHC protocol for uplink if drb-ContinueEHC-UL is not configured; for UM DRBs and signal radio bearers (SRBs), set TX_NEXT to the initial value; for SRBs, discard all stored PDCP SDUs and PDCP PDUs; apply the ciphering algorithm and key provided by upper layers during the PDCP entity re-establishment procedure; apply the integrity protection algorithm and key provided by upper layers during the PDCP entity re-establishment procedure; for UM DRBs, for each PDCP SDU already associated with a PDCP sequence number (SN) but for which a corresponding PDU has not previously been submitted to lower layers, and for AM DRBs for Uu interface whose PDCP entities were suspended, from the first PDCP SDU for which the successful delivery of the corresponding PDCP Data PDU has not been confirmed by lower layers, for each PDCP SDU already associated with a PDCP SN, consider the PDCP SDUs as received from upper layer and perform transmission of the PDCP SDUs in ascending order of the COUNT value associated to the PDCP SDU prior to the PDCP re-establishment without restarting the discardTimer, and for AM DRBs whose PDCP entities were not suspended, from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment, which may comprise performing header compression of the PDCP SDU using ROHC and/or using EHC, performing integrity protection and ciphering of the PDCP SDU using the COUNT value associated with this PDCP SDU, and/or submit the resulting PDCP Data PDU to lower layer.

During PDCP re-establishment, the WTRU may perform one or more of the following for the receiving PDCP entity (e.g., concerning UL data): process the PDCP Data PDUs that are received from lower layers due to the re-establishment of the lower layers; for SRBs, discard one or more (e.g., all) stored PDCP SDUs and PDCP PDUs; for SRBs and UM DRBs, if t-Reordering is running, stop and reset t-Reordering and for UM DRBs, deliver one or more (e.g., all) stored PDCP SDUs to the upper layers in ascending order of associated COUNT values after performing header decompression; for AM DRBs for Uu interface, perform header decompression using ROHC for one or more (e.g., all) stored PDCP SDUs if drb-ContinueROHC is not configured; for AM DRBs for PC5 interface, perform header decompression using ROHC for one or more (e.g., all) stored PDCP IP SDUs; for AM DRBs for Uu interface, perform header decompression using EHC for one or more (e.g., all) stored PDCP SDUs if drb-ContinueEHC-DL is not configured; for UM DRBs and AM DRBs, reset the ROHC protocol for downlink and start with NC state in U-mode if drb-ContinueROHC is not configured; for UM DRBs and AM DRBs, reset the EHC protocol for downlink if drb-ContinueEHC-DL is not configured; for UM DRBs and SRBs, set RX_NEXT and RX_DELIV to the initial value; apply the ciphering algorithm and key provided by upper layers during the PDCP entity re-establishment procedure; and/or apply the integrity protection algorithm and key provided by upper layers during the PDCP entity re-establishment procedure.

Re-establishment procedures may ensure that data that was already encrypted and/or integrity protected with the previous keys will not be transmitted (e.g., in the UL) or wrongly received in the DL (e.g., the WTRU will not try to decrypt or integrity verify an old packet that was encrypted and integrity protected using the old keys). The MAC may be reset, ensuring that any pending UL/DL data that is associated with the old keys at the MAC level is also discarded. The WTRU may refrain from performing re-establishment of radio resource control (RRC), packet data convergence protocol (PDCP), and radio link control (RLC) entities. The WTRU may also refrain from resetting medium access control (MAC) and physical layer entities.

Inter-cell L1/L2 mobility may be used to manage beams (e.g., in a CA case). Mechanism(s) and/or procedures of L1/L2-based inter-cell mobility for mobility latency reduction may be specified. Such mechanisms and/or procedures may comprise: configuration and maintenance for multiple candidate cells to allow fast application of configurations for candidate cells (e.g., for RAN2 and/or RAN3); dynamic switch mechanism among candidate serving cells (including SpCell and SCell) for the potential applicable scenarios based on L1/L2 signaling (e.g., for RAN1 and/or RAN2); L1 enhancements for inter-cell beam management, including L1 measurement and reporting, and beam indication (e.g., for RAN1 and/or RAN2); TA management (e.g., for RAN1 and/or RAN2); and/or CU-DU interface signaling to support L1/L2 mobility (e.g., for RAN3). Early RAN2 involvement may be useful, including further clarifying the interaction between L1 enhancements for inter-cell beam management and the dynamic switch mechanism. FR2-specific enhancements, if any, may not be precluded.

L1/L2-based inter-cell mobility may be applicable to one or more of the following: standalone, CA and NR-DC case with serving cell change within a (e.g., one) CG; Intra-DU case and intra-CU inter-DU case (e.g., applicable for Standalone and CA: no new RAN interfaces are expected); both intra-frequency and inter-frequency; both FR1 and FR1; source and target cells may be synchronized or non-synchronized; and the Inter-CU case may not be included.

Inter-cell beam management may address intra-DU and intra-frequency scenarios. In this case, the serving cell may remain unchanged (e.g., there is no possibility to change the serving cell using L1/L2 based mobility). In FR2 deployments, CA may be used in order to exploit the available bandwidth (e.g. to aggregate multiple CCs in one band). These CCs may be transmitted with the same analog beam pair (e.g., gNB beam and WTRU beam). The WTRU may be configured with TCI states (can have fairly large number, e.g. 64) for reception of PDCCH and PDSCH. A (e.g., each) TCI state may comprise a RS or SSB that the WTRU refers to for setting its beam. The SSB may be associated with a non-serving PCI. MAC signaling (e.g., “TCI state indication for WTRU-specific PDCCH MAC CE”) may activate the TCI state for a Coreset/PDCCH. Reception of PDCCH from a non-serving cell may be supported by MAC CE indicating a TCI state associated to non-serving PCI. MAC signaling (e.g., “TCI States Activation/Deactivation for WTRU-specific PDSCH”) may activate a subset of (e.g., up to) 8 TCI states for PDSCH reception. DCI may indicate which of the 8 TCI states. A “unified TCI state” may be supported with a different updating mechanism (e.g., DCI-based), but without multi-TRP. Unified TCI state with multi-TRP may be supported.

The overall objective of L1/L2 inter-cell mobility may be to improve handover latency; with a conventional L3 handover or conditional the WTRU may first send a measurement report using RRC signaling. In response to this the network may provide a further measurement configuration and potentially a conditional handover configuration. With a conventional handover the network may provide a configuration for a target cell after the WTRU reports using RRC signaling that the cell meets a configured radio quality criteria. With conditional handover, in order to reduce the handover failure rate due to the delay in sending a measurement report and then receiving an RRC reconfiguration, the network may provide (e.g., in advance) a target cell configuration as well as a measurement criteria, which may determine when the WTRU should trigger the CHO configuration. Both of these L3 methods, however, do suffer from some amount of delay due to the sending of measurement reports and receiving of target configurations, particularly in case of the conventional (e.g., non-conditional) handover.

The aim of L1/L2 based inter-cell mobility may be to allow a fast application of configurations for candidate cells, including dynamically switching between SCells and switching of the PCell (e.g., switch the roles between SCell and PCell) without performing RRC signaling. The inter-CU case may not be included, as this may comprise relocation of the PDCP anchor. Therefore, an RRC-based approach may be employed at least to support inter-CU handover. One of the aims of L1/L2 should also be to allow CA operation to be enabled instantaneously upon serving cell change.

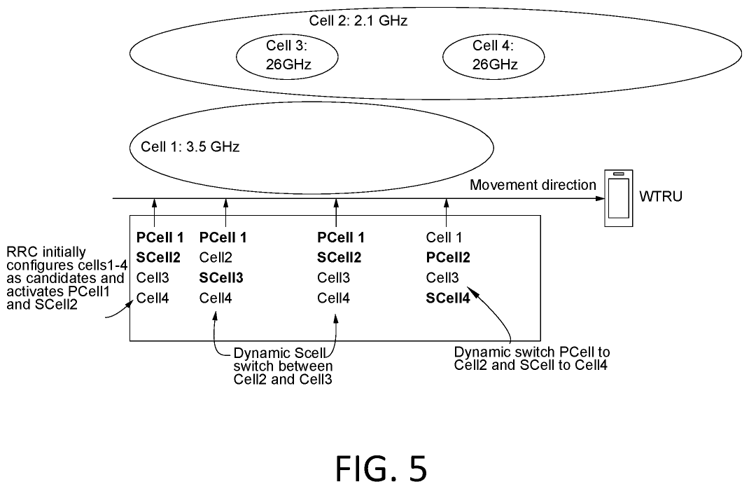

FIG. 5 shows an example of L1/L2 inter-cell mobility operation, whereby the candidate cell group is configured by RRC and a dynamic switch of PCell and SCell is achieved using L1/L2 signaling.

The WTRU may receive first downlink data from a source cell (e.g., PCell 1 and/or SCell 2) using a first security context. In some cases in this disclosure, “receiving” data may comprise “processing” said data. The WTRU may process the first downlink data using the first security context. The WTRU may be configured via RRC with cells 1-4 as candidate cells and activate PCell1 and SCell2. The WTRU may receive, from the source cell, configuration information indicating one or more candidate cells for Layer 1 or Layer 2 (L1/L2) triggered mobility (LTM). The WTRU may receive configuration information indicating a plurality of mobility candidate cells and a plurality of measurement configurations. The base station may execute L1/L2 signaling for Scell activation/deactivation (intra-CU). CHO for Pcell switch (intra or inter-CU) may take place, and the “set” of L1/L2 candidates may be updated. The WTRU may activate a first measurement configuration of a plurality of measurement configurations based on a first cell being a current serving cell for the WTRU. The WTRU may also determine that a second measurement configuration of the plurality of measurement configurations is deactivated based on the first cell being a current serving cell for the WTRU.

As the WTRU performs mobility from left to right, the WTRU may switch (e.g., switch dynamically) the Scell between Cell2 and Cell3. The WTRU may receive, from the source cell, a LTM indication to perform a handover (HO) to a candidate cell (e.g., SCell 3) among the one or more candidate cells. The LTM indication to perform the HO may indicate that a special cell (SpCell) associated with the WTRU is to be changed. The WTRU may determine a second security context associated with the candidate cell. Determining the second security context may comprise deriving a new key for the candidate cell (KgNB) and calculating, using a physical cell identification (PCI) and a frequency of a primary cell (PCell), one or more integrity protection keys and decryption keys using the candidate cell. The higher frequency and higher bandwidth of Cell3 and Cell4 may be a factor in the determination (or conditions) for switching to a target cell (e.g., candidate cell). The WTRU may receive Layer 1 or Layer 2 (L1/L2) control signaling indicating that the WTRU is to perform mobility to a second cell, the second cell being one of the plurality of mobility candidate cells. The WTRU may still process second downlink data using the first security context.

As the WTRU continues to perform mobility to the right, the WTRU may switch (e.g., switch dynamically) the PCell to Cell2 and switch (e.g., dynamically switch) the SCell to Cell4. The WTRU may determine which of the plurality of measurement configurations are to be activated and which of the plurality of measurement configurations are not to be activated upon performing mobility to the second cell (e.g., the second cell being a primary cell) based on the second cell being a new serving cell for the WTRU and the mobility to the second cell causing an activation of a third cell of the plurality of mobility candidate cells as a secondary cell. The second measurement configuration may also be determined to be activated. The WTRU may be configured to determine which of a plurality of measurement configurations are to be activated and which of the plurality of measurement configurations are not to be activated upon performing mobility to the second cell (e.g., PCell 1 to PCell 2) based on one or more conditions being met. The WTRU may also be configured to determine which of the plurality of measurement configurations are to be activated and which of the plurality of measurement configurations are not to be activated upon performing mobility to the second cell based on a combination of currently active secondary cells (SCells) in the plurality of mobility candidate cells.

In FIG. 5, L1 (e.g., DCI, activating unified TCI state) or L2 (e.g., MAC CE) signaling may be used to dynamically switch the roles of these four pre-configured cells. The WTRU may receive Layer 1 or Layer 2 (L1/L2) control signaling indicating that the WTRU is to perform mobility to a second cell, the second cell being one of the plurality of mobility candidate cells. “Cell”, for example, may refer to a PCell, SCell, mobility candidate cell, activated cell, deactivated cell, first cell, second cell, third cell, fourth cell, fifth cell, nth cell or any other cell. The WTRU performing mobility may comprise the WTRU moving in a certain direction. The WTRU performing mobility may comprise projections, estimations, measurements, and/or calculations regarding a speed, direction, acceleration, and/or one or more locations regarding the WTRU. For example, if the WTRU is moving right, the WTRU, Layer 1, Layer 2, and/or Layer 3 may project where the WTRU will be located in a given amount of time and activate the desired measurement configurations and deactivate the undesirable measurement configurations. The location of the WTRU within a cell (e.g., the region of the cell that the WTRU is in) may also be used to determine which measurement configurations are activated and deactivated. For example, in FIG. 5, when WTRU is on the far-left side of Cell 1, the measurement configurations related to Cell 4 may be deactivated because Cell 4 is toward the far-right side of Cell 1. When WTRU is in the middle of Cell 1, measurement configurations related to Cell 3 may be activated because Cell 3 is right above (e.g., proximal) to the center of Cell 1.

The WTRU may determine which of the plurality of measurement configurations are to be activated and which of the plurality of measurement configurations are not to be activated upon performing mobility to the second cell based on the second cell being a new serving cell for the WTRU and the mobility to the second cell causing an activation of a third cell of the plurality of mobility candidate cells as a secondary cell, the second cell being a primary cell, wherein the second measurement configuration is determined to be activated. For example, in FIG. 5, the WTRU performs mobility from PCell 1 to PCell 2, which causes an activation of Cell 4 as the secondary cell (SCell4), wherein the secondary cell was previously Cell 2. Radio resource control (RRC) may be the highest layer in the control plane of the access stratum (AS). RRC may transfer messages of the non-access stratum (NAS), which is located above the RRC layer. In addition, in an embodiment, the network may provide one or more (in this example, 2) conditional handover configurations with target cells. The WTRU may be configured to determine which of the plurality of measurement configurations are to be activated and which of the plurality of measurement configurations are not to be activated upon performing mobility to the second cell based on a combination of currently active secondary cells (SCells) in the plurality of mobility candidate cells.

In the 3GPP standard up to Release 17, when multiple conditional handover configurations are provided, the WTRU stores these and evaluates the trigger conditions in parallel. With the proposed method, these CHO configurations may not become active immediately upon configuration (for example, a flag comprised in the measurement/CHO configuration that the concerned configuration may be stored) and may be activated in one or more ways, such as using explicit L1/L2 signaling indicating to activate the CHO or measurement configuration. Further activation examples may comprise when a certain cell becomes the PCell, when a certain SCell (e.g., or set of SCells) gets activated, when a certain SCell (e.g., or set of SCells) gets deactivated, when a certain PCell/SCell combination becomes active or is deactivated, and upon certain changes of combination (e.g., Pcell1->PCell2 change activates the configuration, but PCell3->PCell2 change may not).

In embodiments, similar mechanisms may be employed to deactivate an active CHO or measurement configuration. Other mechanisms may be employed to release/delete an active or inactive CHO or measurement configuration.

The embodiments may be used, for example, in the case of L3 handover. In embodiments, a CHO or CPAC configuration may be provided but not activated until a certain SpCell and/or one or more Scells become active, regardless whether L1/L2 triggered mobility is used. In embodiments, the WTRU may execute a CPC based configuration on an active configuration for the current serving cells. In embodiments, the WTRU may activate and begin to evaluate a stored CPC configuration that is, for example, associated with the new serving cells. In embodiments, procedures relating to a cell change that is activated or triggered using an explicit L1/L2 command may also apply to cell changes using a L3 RRC Reconfiguration or a CHO, CPC or CPA. In certain cases, a WTRU may determine that a second measurement configuration of the plurality of measurement configurations is deactivated based on the first cell being a current serving cell for the WTRU.

A first CHO configuration may be provided with a target cell and a measurement event to trigger the CHO such as CondEvent A3 (e.g., Neighbor becomes offset better than SpCell) or CondEvent A5 (e.g., SpCell becomes worse than threshold1 and neighbour becomes better than threshold2). The network may not know which direction the WTRU will move in, so the network may set up targets in multiple directions around the WTRU (e.g., left, right, forward, backward, up, down). The WTRU may be configured to activate the first CHO configuration based on Cell 1 being the PCell. As the WTRU performs mobility from left to right, the WTRU may switch (e.g., dynamically switch) the Scell between Cell2 and Cell3. As the WTRU continues to move right, the WTRU may switch (e.g., dynamically switch) the PCell from Cell1 to Cell2, and switch (e.g., dynamically switch) the SCell from Cell2 to Cell4. The WTRU may process third downlink data from the candidate cell (e.g., PCell 2, SCell 4) using the second security context upon a determination that one or more conditions are met. Processing the third downlink data may comprise performing integrity verification and decryption using the one or more integrity protection keys and decryption keys associated with the second security context.

The WTRU may be configured to use the second security context, and refrain from using the first security context, upon the determination that one or more conditions are met. The one or more conditions may comprise a determination that a certain time has elapsed from the reception of the LTM indication to perform the HO, a determination that an integrity verification with one or more old security keys has failed, and/or a determination that an end marker packet is received. The end marker packet may comprise one or more of a dummy radio resource control (RRC) message, a packet data convergence protocol (PDCP) control protocol data unit (PDU) that comprises an indication to use the second security context, or a field in a PDCP data PDU header that comprises an indication to use the second security context. After the determination that one or more conditions are met, the WTRU may transmit third uplink data that is encrypted using the second security context. The one or more old security keys may be associated with the first security context. And the first security context may comprise one or more security keys (e.g., the one or more old security keys).

The WTRU may perform one or more measurements associated with a second measurement configuration. For example, in FIG. 5, a second CHO configuration may be provided with a target cell and a measurement event to trigger the CHO, similar to the first CHO configuration. The second CHO configuration may also be activated based on Cell 2 being the PCell (e.g., or alternatively the combination of PCell 1 and SCell 4 may activate the second CHO configuration). Rather than evaluating all of the configured CHOs in parallel, the WTRU may evaluate the CHO(s) according to the associated combination of active cells. This may reduce the processing overhead in the WTRU, such that the relevant measurements and evaluation may be performed depending on the WTRU location within the L1/L2 mobility area. This also may reduce the resource usage in the network. The WTRU may refrain from performing re-establishment of radio resource control (RRC), packet data convergence protocol (PDCP), and radio link control (RLC) entities. The WTRU may also refrain from resetting medium access control (MAC) and physical layer entities.

The network may not need to reserve resources on all configured target CHO cells, but rather may reserve resources according to the activated CHO configuration, for example, since the network may be in control (e.g., using L1/L2 signaling) of the combination of active cells used by the WTRU, the network also has control of what the target CHO cells and the currently active CHO configurations in the WTRU are. The same or similar method may also be used to control measurement objects and measurement reporting for conventional handover. The WTRU may send a measurement report via a second cell based on the measurements associated with the second measurement configuration. For instance, instead of or in addition to one or more CHO configurations, one or more measurement objects may be configured for measurement reporting and associated to one or more L1/L2 controlled cell combinations. Additionally, the carriers and/or the cells (e.g., neighbor carriers and cells) that are currently measured by the WTRU may be associated with the L1/L2 controlled cell combinations.

Activating Measurement Configurations and/or Conditional Reconfiguration(s) may be based on any “conditions” representing where the WTRU may be located within the L1/L2 mobility area or within an area corresponding to a set of cells with preconfigured measurements or CHO/CPAC. The conditions may comprise which PCell and/or SCell(s) are activated, and may comprise cases where there may be no active SCell and/or SCell might be de-activated for power saving reasons.

A “mobility area index” may be introduced and configured in each instance of “X” and “Y” with at least one “mobility area index”. In the embodiment, “X” may comprise anything that may be activated/deactivated as a function of the location of the WTRU, for example: TCI state, non-serving PCI (e.g., within “NumberOfAdditionalPCI”), PCell/SCell combinations, active bandwidth part (BWP), SCell activation state, a measurement event trigger condition being met, a DL synchronization trigger to a candidate cell, a PDCCH ordered RA towards a candidate cell, and/or enabling of radio link monitoring (RLM) or beam failure detection (BFD) of a target cell. In some examples, the non-serving PCI may be activated if a TCI state associated with the PCI is activated.

“Y” may comprise anything that supports measurements/mobility, for example, a configured measurement configuration, a configured conditional reconfiguration and/or channel state information (CSI) reporting configuration, a BFR configuration, and/or neighbor carrier/cell list. A configured measurement configuration may comprise a L3 measurement object, a L1 or L3 measurement event, a CSI measurement configuration, and/or a L1 or L3 measurement RS configuration (e.g., SSB or CSI-RS resource for a current or neighbor cell). A configured measurement configuration may comprise a PCI or logical ID, SMTC location, frequency location, and/or SCS.

Based on the above, it is contemplated that the examples of the possible behaviors may, for example, comprise if “X” is activated, then any “Y” with same “mobility area index” configured for X is also activated. In some examples, Y may be deactivated if there is no activated “X” with same “mobility area index”. In some examples, an explicit activation/deactivation or switching of “mobility area index” may occur, which may activate/deactivate a corresponding X and/or Y.

One example of a “mobility area index” could be one or more indexes or identifiers associating “X” (e.g., anything that could be activated/deactivated as a function of the location of the WTRU) with “Y” (e.g., anything that supports measurements/mobility). For example, the WTRU may be configured with one or more measurement configurations which each have an index. The WTRU may additionally be configured with one or more conditions (e.g., SpCell/SCell combinations) and/or a list of one or more indexes identifying the measurement configurations to enable when the one or more conditions are satisfied. Each of the configured conditions may be associated with the same or a different subset of measurement configurations. In this way, a measurement configuration may not need to be repeated for every possible SpCell/SCell combination, but each of the combinations for which the measurement configuration is applicable (e.g., an SpCell/Scell combination configured as a L1/L2 mobility candidate configuration) can reference the measurement configuration (e.g., configured in an independent list or structure from L1/L2 mobility candidate configurations) using the index or identifier. In addition, this allows a larger number of measurements to be configured (e.g., by RRC) than will be applicable for any given SpCell/SCell combination (e.g., activated or triggered by MAC CE).

As used herein, an L1/L2 mobility indication may be any L1/L2 signaling (e.g., PHY DCI, MAC CE, etc). Unless otherwise specified, the embodiments disclosed herein are equally applicable to the case of single connectivity (e.g., only MCG configured) as well as the dual connectivity (DC) case (e.g., where an SCG is also configured). In the case of DC, the L1/L2 mobility indication for the SCG may be received either from the MCG or the SCG.

As described herein, the L1/L2 mobility indication may change the PCell, the PSCell, and/or both (e.g., simultaneously or sequentially).

The term “concerned cell group” may refer to the cell group to which the L1/L2 mobility indication is referring (e.g., the master cell group (MCG), if the L1/L2 mobility indication is changing the PCell, the secondary cell group (SCG), if the L1/L2 indication is changing the SCell). When it is used to refer to the bearers, bearers of the concerned cell group may be bearers where the PDCP is associated/terminated at that cell group. For example, if the L1/L2 mobility indication is regarding the MCG (e.g., PCell change) the concerned bearers may be MCG terminated MCG bearers, MCG terminated split bearers or MCG terminated SCG bearers. Similarly, if the L1/L2 mobility indication is regarding the SCG (e.g., PSCell change) the concerned bearers may be SCG terminated SCG bearers, SCG terminated split bearers, or SCG terminated MCG bearers.

The terms “security context” and “security keys” may be used interchangeably herein.

The term “a packet associated with a certain security key/context” may refer to a packet that is integrity protected and/or encrypted using the concerned security keys.

PDCP/RLC re-establishment may be triggered. Upon the reception of the L1/L2 mobility indication that changes the SpCell, the WTRU may implicitly trigger the re-establishment of the PDCP entities of all the radio bearers. It should be noted that in legacy NR, the PDCP re-establishment for a given bearer may be triggered (e.g., only) upon the reception of an explicit indication in the PDCP configurations related to that bearer (e.g., in the case of HO, the network may indicate to the WTRU, for each bearer, to re-establish the associated PDCP entity). The implicit re-establishment of the PDCP entities may also trigger the re-establishment of the RLC associated with the bearers for the concerned cell group.

If the WTRU was configured with split bearers, the implicit re-establishment of the PDCP entities may also trigger the re-establishment of one or more (e.g., all) of the RLC entities associated with the concerned bearers, including those for the other cell group. For example, an L1/L2 mobility indication for changing the PCell may result in the WTRU re-establishing the PDCP of one or more of (e.g., all) the bearers of the MCG, the RLC associated with these bearers in the MCG, and any RLC associated with these bearers in the SCG (e.g., for split bearers).

The L1/L2 mobility indication may comprise a flag which explicitly indicates whether the PDCP and RLCs of the bearers for the concerned cell group should be re-established. In one example, a value of 0 may indicate the PDCP and RLCs of one or more of (e.g., all) the bearers for the concerned cell group should be re-established. In another example, a value of 1 may indicate the PDCP and RLCs of one or more of (e.g., all) the bearers should be re-established. Alternatively, the L1/L2 mobility indication may comprise a separate flag to indicate whether PDCPs should be re-established and a separate flag to indicate whether the RLCs should be re-established. The L1/L2 mobility indication may comprise a multitude of flags, where each flag is associated with one or more bearers, and indicating whether the PDCP and/or RLC associated with that bearer(s) are to be re-established.

In some cases, MAC reset may be triggered. Upon reception of the L1/L2 mobility indication that changes the SpCell, the WTRU may implicitly trigger the reset of the MAC entity associated with the concerned cell group. Upon reception of the L1/L2 mobility indication that changes the PCell, the WTRU may implicitly trigger the reset of the MAC entity associated with the SCG (e.g., if DC is configured). Upon reception of the L1/L2 mobility indication that changes the PCell, the WTRU may implicitly trigger the reset of the MAC entity associated with the SCG (e.g., if DC is configured), for example (e.g., only) if the WTRU was configured with split bearers.

The L1/L2 mobility indication that changes the SpCell may comprise a flag that indicates whether the MAC associated with the concerned cell group should be reset or not. In an example, a value of 0 may indicate the MAC entity is to be reset, and a value of 1 may indicate the MAC entity should be reset. The reception of a L1/L2 mobility indication that indicates the reset of the MCG MAC may implicitly indicate that the SCG MAC should be reset as well, if the WTRU was configured with DC. The L1/L2 mobility indication that changes the PCell may comprise an explicit flag that indicates whether the MAC associated with the SCG should be reset or not.

One or more of the solutions described herein may be performed without triggering PDCP/RLC re-establishment and/or MAC reset. Upon the reception of a L1/L2 mobility indication that changes the SpCell, the WTRU may refrain from performing re-establishment of the PDCP and RLC entities and/or calculate new security context (e.g., derive the new KgNB based on the new PCI and frequency of the new PCell, calculate the integrity protection and encryption keys for both the UP and CP based on the new K_{gNB}). In the UL, for any new data to be transmitted at the PDCP level, the WTRU may integrity protect and/or encrypt the packet using the new keys, and for old data that is already integrity protected and/or encrypted using the old security keys, the WTRU may pass the data to the RLC/MAC entities. In the DL, at PDCP level, the WTRU may first attempt integrity verification of the received packets using the old security keys. If the integrity verification is unsuccessful, the WTRU may attempt to verify the integrity of the data using the new security keys. If verifying the integrity of the data using the new security keys is successful, the WTRU may delete the old security context and use the new security keys from then onwards; if it is unsuccessful, the WTRU may trigger radio link failure.

A sequence of parity bits may be comprised in the PDCP header. These parity bits may consist of a known sequence which is either preconfigured (e.g., in the standard) or derived (e.g., from a cell ID, WTRU-ID, or other variable parameter known to both the transmitter and receiver). The purpose of the parity bits may be to enable an integrity verification test of security keys, such that the receiver may perform the integrity verification of the parity bits using the old and new keys to determine which is the correct key (e.g., if the result of applying the currently used/tested security key to the sequence of parity bits matches the expected outcome, then it can be determined that the currently used/tested key is the one used at the transmitter, and the WTRU can proceed to use this key for processing the remainder of the PDU).

Upon the reception of the L1/L2 mobility indication, the WTRU may start a timer (e.g., the value of the timer may be configured by the network or based on WTRU implementation). Until this timer expires, the WTRU may keep operating the same way as described herein (e.g., use the old keys first, and if that doesn't succeed, use the new keys). When the timer expires, the WTRU may delete the old security context and use (e.g., only) the new security context from then onwards.

The WTRU may start the security context switching timer (e.g., the value of the timer may be configured by the network or based on WTRU implementation) when the integrity verification with the old keys fails but the verification with the new security keys succeeds for the first time. Until this timer expires, the WTRU may keep operating the same way (e.g., use the old keys first, and if that doesn't succeed, use the new keys). When the timer expires, the WTRU may delete the old security context and use only the new security context from then onwards.

When the integrity verification with the old keys fails but the verification with the new security keys succeeds, the WTRU may further check the PDCP sequence number (SN) of the concerned packet. If the packet was received in sequence (e.g., no missing packet with a lower SN than the current packet), the WTRU may delete the old security context. If the packet was received out of sequence (e.g., one or more packets with a lower SN than the current packet still not received), the WTRU may keep the old security context. The old security context may be used to integrity verify and decrypt the missing packets while the new security context may be used to integrity verify and decrypt the new packets (e.g., packets with SN greater than the current packet). Once (e.g., all) these missing packets are received, the WTRU may delete the old security context.

Since integrity protection is an optional feature for the WTRU, in some cases it may not be possible for the WTRU to detect the moment to switch the security context completely.

The network may send a dummy RRC message (e.g., as RRC messages are always integrity protected) that is associated with the new security keys. The WTRU may consider this as an indication that (e.g., only) the new security keys may be used from then onwards, or after a certain time has elapsed after the reception of this dummy RRC packet. In an example, the WTRU may refrain from sending any RRC complete message associated with the dummy RRC message.

The network may send a security context switch indicator (e.g., or end marker) (e.g., PDCP control PDU) that indicates to the WTRU to switch the security context from then onwards (e.g., or start the security context switch timer as disclosed herein).

The WTRU may determine whether to use the new security context or the old one based on information in the PDCP data PDU header (e.g., one or more reserved bits in the PDCP data PDU header). For example, a value of 1 in one of the reserved bits may indicate that this PDCP PDU, and any PDU with a SN greater than this PDU may be associated with the new security context.

A bit in the PDU header may be toggled between two values (e.g., “0” and “1”) each time the security keys are changed, such that one or more (e.g., all) PDUs generated using a first security key (e.g., before the PCell change) indicate a first value in the PDU header, and one or more (e.g., all) PDUs generated using a second security key (e.g., after the PCell change) indicate a second value in the PDU header. In this way, one or more (e.g., every) PDU headers may contain an indication of which PDUs use the old and the new keys, which may be used at the receiver, particularly in case of out of order delivery, to determine which security key to apply. This may alternatively be multiple bits, for example a counter value which may be incremented each time the security keys are changed, or an index to one of multiple security keys. This may provide a further benefit, for example in the case that the PCell changes multiple times in quick succession, such that it becomes possible to receive data using more than two different security keys out of order.

The WTRU may send a security context switch indicator (or end marker) (e.g., PDCP control PDU) that indicates to the network that it has started using the new security keys. The WTRU may indicate to the network that it has started using the new security keys by setting a flag in the PDCP data PDU header (e.g., one or more reserved bit in the PDCP data PDU header). The WTRU may send a dummy RRC message to the network associated with the new security keys, to indicate to the network that the WTRU has started using the new security keys. The end marker may be sent by the network or WTRU at another layer than the PDCP (e.g., RLC control PDU, MAC CE, etc.).

The WTRU may make the decision for changing the security context, as disclosed herein, for one bearer at a time. For example, if a PDCP control PDU is used, the control PDU is sent for a (e.g., each) PDCP (e.g., each bearer). Alternatively, the WTRU may make the decision for changing the security context, as disclosed herein, for one or more (e.g., all) bearers at once. For example, if the WTRU has detected the new keys work for a packet of a certain bearer, it may start using the new keys even for packets that belong to other bearers than the concerned packet where the security context switch was detected (e.g., or start the security context switch timer as disclosed herein).

The WTRU may keep a multitude of security contexts at a given time. For example, the WTRU may generate the security context for any of the candidate cells that are part of the L1/L2 mobility cell and can be upgraded to a PCell using L1/L2 mobility indication (e.g., generate the K_{gNB} and associated integrity verification and encryption keys assuming the candidate cell is the PCell). A (e.g., each) security context may be associated with an identity (e.g., serving cell index of the concerned candidate cell). A (e.g., each) PDU header may contain an identifier (e.g., serving cell index) such that the receiver can determine which security context was used for generating the received PDU, or a bit (e.g., toggled each time the security context changes) which indicates whether a security context associated with the previous PCell or a security context associated with the current PCell was used for generating the PDU.

The WTRU may be configured to use a given security context for a certain bearer (e.g., as compared to using one security context for all bearers). The WTRU may be configured to use a different security context in the UL and DL for a given bearer. The WTRU may be configured to change the security context for a given bearer from one packet to another. For example, the PDCP data PDU header may comprise an indication (e.g., a security context ID, as indicated via the one or more reserved bits of the PDCP data PDU header) that is to be used for a given packet.

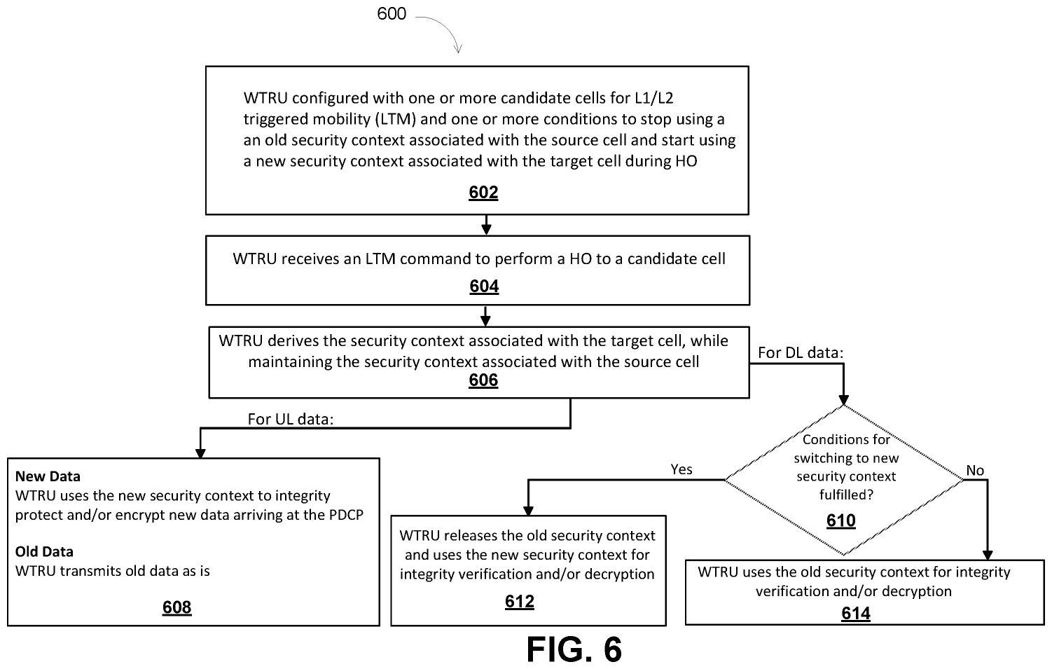

FIG. 6 illustrates an example of L1/L2 triggered mobility (LTM) using and old security context and/or a new security context as disclosed above. At 602, a WTRU may process first downlink data from a source cell using a first security context. The WTRU may receive, from the source cell, configuration information indicating one or more candidate cells for Layer 1 or Layer 2 (L1/L2) triggered mobility (LTM). The WTRU may be configured with one or more of the following: one or more candidate cells for L1/L2 triggered mobility (LTM), and one or more conditions to stop using a security context associated with the source cell (e.g., old security context, first security context) and start using the security context associated with the target cell (e.g., new security context, second security context) during HO. The one or more conditions may comprise: a certain time elapsing after the reception of an LTM command/indication to perform the HO, failure of an integrity verification using old the security context, and/or receiving an end marker. The end marker packet may comprise one or more of a dummy radio resource control (RRC) message, a packet data convergence protocol (PDCP) control protocol data unit (PDU) that comprises an indication to use the second security context, and/or a field in a PDCP data PDU header that comprises an indication to use the second security context.

The one or more old security keys may be associated with the first security context. And the first security context may comprise one or more security keys (e.g., the one or more old security keys). Determining the second security context may comprise deriving a new key for the candidate cell (KgNB) and calculating, using a physical cell identification (PCI) and a frequency of a primary cell (PCell), one or more integrity protection keys and decryption keys using the candidate cell. Processing the third downlink data may comprise performing integrity verification and decryption using the one or more integrity protection keys and decryption keys associated with the second security context.

At 604, the WTRU may receive, from the source cell, an LTM command/indication to perform a HO to a candidate cell among the one or more candidate cells. The LTM indication to perform the HO may indicate that a special cell (SpCell) associated with the WTRU is to be changed. Prior to receiving the LTM indication to perform the HO, the WTRU may transmit first uplink data to the source cell using the first security context. After receiving the LTM indication to perform the HO, the WTRU may transmit second uplink data to the candidate cell that is encrypted using the second security context.

At 606, the WTRU may determine a second security context associated with the candidate cell. The WTRU may derive the security context associated with the target cell, while maintaining the security context associated with the source cell.

At 608, for uplink (UL) data, the WTRU may use the new security context to integrity protect and/or encrypt new data arriving at the packet data convergence protocol (PDCP). For old data that is already integrity protected and/or encrypted using the old security context, the WTRU may transmit the data as is.

At 610, the WTRU may determine if one or more conditions for switching to the new security are fulfilled.

At 612, if one or more conditions for switching to the new security context are fulfilled, the WTRU may release the old security context and start using the new security context for integrity verification and decryption. The WTRU may use the second security context, and refrain from using the first security context, upon the determination that one or more of the conditions are met. The WTRU may process third downlink data from the candidate cell using the second security context upon a determination that one or more of the conditions are met. The one or more conditions may comprise: a determination that a certain time has elapsed from the reception of the indication to perform the LTM HO, a determination that an integrity verification with one or more old security keys has failed, or a determination that an end marker packet is received. The one or more old security keys may be associated with the first security context. In some cases, the WTRU may use the first security context (or the second security context) for integrity verification and/or decryption of data already in a WTRU buffer (e.g., PDCP buffer and/or MAC buffer). After the determination that one or more of the conditions are met, the WTRU may transmit third uplink data that is encrypted using the second security context.

At 614, if one or more of the conditions for switching to the new security context are not fulfilled, the WTRU may use the old security context for integrity verification and decryption. That is, the WTRU may process second downlink data using the first security context. Handovers initiated by LTM may have several benefits. In certain cases, the WTRU may refrain from or limit performing re-establishment of radio resource control (RRC), packet data convergence protocol (PDCP), and radio link control (RLC) entities. The WTRU may also refrain from or limit resetting medium access control (MAC) and physical layer entities.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media comprise, but are not limited to, electronic signals (transmitted over wired and/or wireless connections) and/or computer-readable storage media. Examples of computer-readable storage media comprise, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit receive unit (WTRU) comprising:
a processor configured to:
process first downlink data from a source cell using a first security context;
receive, from the source cell, configuration information indicating one or more candidate cells for Layer 1 or Layer 2 (L1/L2) triggered mobility (LTM);
receive, from the source cell, an LTM indication to perform a handover (HO) to a candidate cell among the one or more candidate cells;
determine a second security context associated with the candidate cell; process second downlink data using the first security context; and
process third downlink data from the candidate cell using the second security context upon a determination that one or more conditions are met, wherein the one or more conditions comprise:
a determination that a certain time has elapsed from the reception of the LTM indication to perform the HO;
a determination that an integrity verification with one or more old security keys has failed; or
a determination that an end marker packet is received.

2. The WTRU of claim 1, wherein the end marker packet comprises one or more of a dummy radio resource control (RRC) message, a packet data convergence protocol (PDCP) control protocol data unit (PDU) that comprises an indication to use the second security context, or a field in a PDCP data PDU header that comprises an indication to use the second security context.

3. The WTRU of claim 1, wherein the processor is configured to:
prior to receiving the LTM indication to perform the HO, transmit first uplink data to the source cell using the first security context;
after receiving the LTM indication to perform the HO, transmit second uplink data to the candidate cell that is encrypted using the second security context; and
after the determination that at least one of the one or more conditions are met, transmit third uplink data that is encrypted using the second security context.

4. The WTRU of claim 1, wherein the one or more old security keys are associated with the first security context.

5. The WTRU of claim 1, wherein the processor is configured to use the second security context, and refrain from using the first security context, upon the determination that the at least one of the one or more conditions are met.

6. The WTRU of claim 1, wherein the first security context comprises one or more security keys.

7. The WTRU of claim 1, wherein determining the second security context comprises deriving a new key for the candidate cell (KgNB) and calculating, using a physical cell identification (PCI) and a frequency of a primary cell (PCell), one or more integrity protection keys and decryption keys.

8. The WTRU of claim 7, wherein processing the third downlink data comprises performing integrity verification and decryption using the one or more integrity protection keys and decryption keys associated with the second security context.

9. The WTRU of claim 1, wherein the LTM indication to perform the HO indicates that a special cell (SpCell) associated with the WTRU is to be changed.

10. The WTRU of claim 1, wherein the processor is further configured to:
refrain from performing re-establishment of radio resource control (RRC), packet data convergence protocol (PDCP), and radio link control (RLC) entities; and
refrain from resetting medium access control (MAC) and physical layer entities.

11. A method performed in a wireless transmit receive unit (WTRU), the method comprising:
processing first downlink data from a source cell using a first security context; receiving, from the source cell, configuration information indicating one or more candidate cells for Layer 1 or Layer 2 (L1/L2) triggered mobility (LTM);
receiving, from the source cell, an LTM indication to perform a handover (HO) to a candidate cell among the one or more candidate cells;
determining a second security context associated with the candidate cell; processing second downlink data using the first security context; and
processing third downlink data from the candidate cell using the second security context upon a determination that one or more conditions are met, wherein the one or more conditions comprise:
a determination that a certain time has elapsed from the reception of the LTM indication to perform the HO;
a determination that an integrity verification with one or more old security keys has failed; or
a determination that an end marker packet is received.

12. The method of claim 11, wherein the end marker packet comprises one or more of a dummy radio resource control (RRC) message, a packet data convergence protocol (PDCP) control protocol data unit (PDU) that comprises an indication to use the second security context, or a field in a PDCP data PDU header that comprises an indication to use the second security context.

13. The method of claim 11, further comprising:
prior to receiving the LTM indication to perform the HO, transmitting first uplink data to the source cell using the first security context;
after receiving the LTM indication to perform the HO, transmitting second uplink data to the candidate cell that is encrypted using the second security context; and
after the determination that at least one of the one or more conditions are met, transmitting third uplink data that is encrypted using the second security context.

14. The method of claim 11, wherein the one or more old security keys are associated with the first security context.

15. The method of claim 11, further comprising using the second security context, and refraining from using the first security context, upon the determination that the at least one of the one or more conditions are met.

16. The method of claim 11, wherein the first security context comprises one or more security keys.

17. The method of claim 11, wherein determining the second security context comprises deriving a new key for the candidate cell (KgNB) and calculating, using a physical cell identification (PCI) and a frequency of a primary cell (PCell), one or more integrity protection keys and decryption keys using the candidate cell.

18. The method of claim 17, wherein processing the third downlink data comprises performing integrity verification and decryption using the one or more integrity protection keys and decryption keys associated with the second security context.

19. The method of claim 11, wherein the LTM indication to perform the HO indicates that a special cell (SpCell) associated with the WTRU is to be changed.

20. The method of claim 11, further comprising:
refraining from performing re-establishment of radio resource control (RRC), packet data convergence protocol (PDCP), and radio link control (RLC) entities; and
refraining from resetting medium access control (MAC) and physical layer entities.
